(19) United States
(12) Patent Application Publication
(10) Pub. No.: US 2020/0016664 A1
(43) Pub. Date: Jan. 16, 2020

(54) ROTARY METAL-CUTTING INSERT AND MOUNTING CARTRIDGE THEREFOR

(71) Applicant: ROTARY TECHNOLOGIES CORPORATION, El Segundo, CA (US)

(72) Inventors: William J. Endres, El Segundo, CA (US); Douglas J. Woodruff, El Segundo, CA (US); John W. Loosemore, El Segundo, CA (US); Thimmaiah G. Kumbera, El Segundo, CA (US)

(21) Appl. No.: 16/563,767

(22) Filed: Sep. 6, 2019

Related U.S. Application Data
(62) Division of application No. 12/350,181, filed on Jan. 7, 2009.
(60) Provisional application No. 61/010,279, filed on Jan. 7, 2008.

(51) Int. Cl. B23B 27/12

(52) U.S. Cl. CPC B23B 27/12; Y10T 407/23; Y10T 407/245; Y10T 407/192

(57) ABSTRACT

The flow of heat energy from the cutting edge rim of a self-propelled round annular rotary cutting element (“insert”) to axial-load and radial-load bearings in a cartridge which rotatably supports the insert on a machine tool body is reduced by defining heat flow paths from the insert rim to cartridge components which engages the bearings to have low thermal conductance relative to heat flow paths from the insert rim to other parts of the cartridge. Control over heat flow path thermal conductance is obtained by selection of materials used between the insert rim and the mentioned cartridge components, by reductions in the cross-sectional areas of the critical heat flow paths, and by combinations of those two techniques. Protection of the bearings from heat enables the insert and the cartridge to be reduced in size. Improved mountings of insert-supportive cartridges to tool bodies are disclosed. The insert and the cartridge preferably are shaped to enable the insert to be positioned on a tool body so that the insert's rake face can have a positive rake orientation relative to a workpiece. Arrangements for controlling cuttings chip formation and for handling cuttings chips also are disclosed.

### CROSS-REFERENCE TO RELATED APPLICATIONS

This application is a divisional of U.S. application Ser. No. 12/350,181, filed Jan. 7, 2009, which claims the benefit of and priority to U.S. Provisional Application No. 61/010,279, filed Jan. 7, 2008, the entire contents of both are incorporated herein by reference.

### FIELD OF INVENTION

This invention pertains to self-propelled rotary cutters useful in machining metals and to a cartridge assembly for rotatably mounting such cutters on a tool body during machining operations during which the cutters are exposed to heat and are subjected to axial and radial loads. More particularly, the invention pertains to compact forms of such cutters and cartridges in which transfer of heat from the cutting edge of the cutter to bearings in the cartridge is reduced and controlled to extend bearing life and to enable cartridge size to be significantly reduced.

### BACKGROUND

U.S. Pat. Nos. 4,477,211 and 6,073,524 illustrate the state of the art from which the present invention provides advances which enable self-propelled rotary cutter elements (commonly called “inserts”) to be used in metal cutting (machining) operations and applications not heretofore possible in important commercial production contexts. A meaningful product context in which self-propelled rotary cutting inserts have found limited commercial use, despite the proven advantages and benefits of them, is in the boring of piston cylinders in modern internal combustion engine blocks. A significant reason for that situation is that the relatively large size of the insert mounting cartridges of the prior art requires the use of tool bodies of such size that the tools are too large for use to bore the smaller cylinder diameters of modern automotive, motorcycle, yard equipment and generator engines.

An advantage of rotary metal-cutting inserts, which move in their holders as they operate to cut metal, over conventional stationary cutter elements, which do not move in their holders as they cut metal, is that rotary inserts have longer useful lives than do stationary cutter elements. That increased useful life is due to the fact that the location on a rotary insert where it engages a workpiece continually changes as cutting occurs because the insert rotates in its holder in response to forces applied to the insert by the workpiece and deformed chips of material removed from the workpiece, and so the insert area of contact with the workpiece and deformed chips does not become as hot as the area of a stationary cutter that engages with a comparable workpiece and deformed chips. However, rotary cutting inserts commonly become quite hot as they function over time in a given machining operation. As shown in U.S. Pat. No. 4,477,211, the mounting structures (commonly called “cartridges”) for rotary cutting inserts include bearings which are loaded to significant levels as they are subjected to the radial and axial loads applied to the round cutting insert by a workpiece as it is cut by the insert.

Heat is a principal cause of bearing failure. The prior art solution to the problem of bearing heating in a cartridge for a rotary cutting insert has been to use robust and comparatively large thrust-load and radial-load bearings in the cartridges. The need for large bearing assemblies caused the cartridges to be large and to require support for the cartridge shaft (about which the insert is rotatable) at the opposite ends of the shaft. Those aspects of prior art rotary cutters and their mounting cartridges, in turn, required the use of relatively large tool bodies in which the cartridges are securely, yet removably, carried. Large tool bodies are not particularly troublesome and application limiting where rotary cutting inserts are used in turning (lathing) and milling machining of a metal workpiece. In the field of boring, however, the prior art need for tool bodies of comparatively large diameter can meaningfully restrict and limit the situation where rotary cutting inserts can be used to good advantage. That having been said, more compact cartridges are still desirable in milling machining applications since a small cartridge allows more cutting inserts to be mounted to a tool body of given diameter.

It is seen, therefore, that needs exist for improvements in rotary cutting inserts, and in cartridges for rotatably mounting such inserts in ways affording use of smaller adequate radial-load and thrust-load bearings, which enable the inserts and cartridges to be defined more compactly, so that smaller tool bodies and tool bodies that hold more cutting inserts can be made and used. Satisfaction of those needs will make possible increased use of rotary cutting inserts in metal in broader metal machining applications.

### SUMMARY OF INVENTION

This invention beneficially addresses the needs identified above. It does so by providing annular rotary cutting inserts which are configured to transfer to a supporting cartridge a meaningfully reduced portion of the thermal energy (heat) acquired by the inserts as they engage and cut a metal workpiece. Also, it does so by defining the cartridge and its bearings in ways which enable the cartridge bearings to receive a reduced portion of the heat transmitted to the cartridge from the insert and which enables the bearings to better rid themselves of heat transmitted to them. Further, it does so by cooperatively arranging the insert and the cartridge to more efficiently transfer machining forces applied to the insert through the cartridge to a tool body carrying the cartridge so the cartridge shaft can be supported at only one end, at any angular orientation about that cartridge shaft, and with no need for different versions of the cartridge for left-hand and right-hand cutting applications. While these improvements can be used to advantage in cartridge and insert sets of conventional size, they enable cartridge and inserts sets to be defined more compactly than heretofore possible for machining loads of given magnitudes, thus enabling meaningful reductions in the size of tool bodies to which a cartridge is mounted.

One way in which the present invention provides these improvements is to define the insert and the manner of its connection to a cartridge so that the connection provides a thermal impedance effect. The thermal impedance effect causes less of the heat in the insert to be transferred to the cartridge, notably to the portions of the cartridge in which the bearings are located, and to cause more of the heat in the insert to be transferred to the environment of the insert. A result is that the cartridge bearings run cooler and with increased useful life.

One aspect of this invention provides a self-propelled rotary metal-cutting insert (element) which includes a body having a central axial hole extending between opposite ends of the body. The hole enables the body to be mounted for rotation about its axis during and in response to cutting engagement of the insert with a workpiece. The body has an exterior surface which extends between the ends of the body. That exterior surface forms a surface of revolution which is concentric to the body's axis. The exterior surface defines a circular cutting edge. The body is defined to impede the transfer of heat generated at the cutting edge across the surface of the body's central hole.

Pursuant to another aspect of the invention, a self-propelled annular, essentially axisymmetric, metal cutting element is adapted to be mounted via a central hole axially through the element for rotation in response to forces applied to the element when the element is engaged at a circumferential cutting edge of the element with a workpiece moving relative to the element. The cutting edge is located intermediate top and bottom ends of the element. The element has an exterior surface which includes the cutting edge and a rake face which is open toward the element top end and which extends from the cutting edge toward the axis. The element defines a central riser which extends above the cutting edge plane. The element's exterior surface includes a circumferential surface of the riser which at a lower end thereof merges into the rake face inwardly from the cutting edge and then extends upwardly at a selected angle relative to the axis. The value and direction of that angle is related to the composition of the workpiece and is defined to control cutting chips created when the element is used to cut the workpiece.

Pursuant to a further aspect of the invention, a self-propelled annular axisymmetric metal cutting element can be mounted via a central hole in the element to rotate about its axis in response to forces applied to it when it is engaged at a circumferential cutting edge with a workpiece moving relative to the element. During such engagement, the element cuts from the workpiece metal which forms cuttings chips. The cutting edge is located between top and bottom ends of the element. The element defines a rake face which is open toward the top end and which extends from the cutting edge toward the axis. The element includes a central riser which extends above the cutting edge plane to the top end. The rake face and the exterior surface of the riser are components of an exterior surface of the element which is a surface of revolution concentric to the axis except for the presence in the rake face and optionally in the riser surface of circumferentially substantially regularly spaced surface features which are present in the element's exterior surface inwardly from the cutting edge to interact with cuttings chips in use of the element.

Another aspect of the invention provides an improvement in a cartridge for rotatably supporting on a tool body a self-propelled annular round metal cutting element which rotates in response to forces applied to the element when a circumferential cutting edge of the element engages a workpiece moving relative to the element. The cartridge includes a central stator mountable to the tool body. The cartridge also includes a rotor which is rotatably mounted to the stator by axial-load and radial-load bearings. The rotor has a cutting element support platform for engaging a bottom end of the element and an axial sleeve which is engageable with the inner diameter of the element. In that context, the improvement is that the rotor is defined compositionally and geometrically to provide increased thermal impedance to the transfer of heat to the rotor bearings from a cutting element supported by the rotor.

A further aspect of the invention provides a cartridge assembly for rotatably mounting a self-propelled annular metal cutting element to a tool body. The cartridge includes an axial stator adapted at a lower end thereof to be fixedly mounted to a tool body. A rotor is rotatable about a circularly cylindrical upper end portion of the stator to which the cutting element is concentrically matable for radial and axial support of the element by the rotor. An insert hold-down cap is releasably engageable with an upper end of the rotor for clamping a cutting element mated with the rotor to the rotor for rotation of the rotor, the cap and the cutting element about the stator. The stator between its lower end and its upper end portion defines an upwardly facing rotor support surface of selected radial extent circumferentially about the stator. The rotor includes a sleeve having an inner diameter greater than the diameter of the stator upper end portion and an outer diameter with which the cutting element is matable. The rotor also includes a circumferential element axial support surface facing upwardly. A circumferential skirt depends from the element support surface and defines a chamber between the interior of the skirt and a lower end portion of the sleeve. An axial-load roller bearing assembly is located in the chamber and is supported by the stator rotor support surface to carry axial loads applied to the rotor. A plurality of elongate radial-load bearing rollers are present in the space between the stator and the inner diameter of the rotor sleeve. The radial-load bearing rollers have their lower ends located within the axial-load bearing assembly and have their upper ends located close to the upper end of the stator.

Another aspect of the invention pertains to the combination of a self-propelled annular rotary metal cutting element with a cartridge which is mountable to a tool body. The cartridge supports the cutting element for rotation concentrically about a cartridge axis. The cutting element rotates in response to engagement of its cutting edge with a workpiece moving relative to the element in use of the element; the element becomes hot as a result of such engagement with a workpiece. The cartridge includes an axial stator adapted to be fixedly secured to a tool body. The cartridge also includes a rotor rotatable about the stator. The rotor concentrically receives the annular cutting element and supports a bottom surface of the cutting element on a support platform of the rotor. The cartridge further includes a hold-down cap which is releasably engagable with an upper end of the rotor to clamp the cutting element between the cap and the support platform so that the cap, the cutting element and the rotor are rotatable together about the stator. Further, the cartridge includes axial-load and radial-load roller bearings disposed respectively in an annulus between the rotor and the stator and between the rotor support platform and the stator. In that context, the cutting element and the cartridge are cooperatively configured and defined to impede the transfer of heat energy generated at the element cutting edge to the bearings within the rotor.

Another aspect of the invention concerns the combination of a self-propelled annular rotary metal cutting element with a cartridge which is mountable to a tool body. The cartridge supports the cutting element for rotation concentrically about a cartridge axis. The cutting element, at a location thereof above a bottom surface of the element, defines a circumferential cutting edge which forms the outer edge of an element rake face extending toward the axis and facing away from the element bottom surface. The cartridge includes a rotor which axially supports the cutting element via the element bottom surface. The rotor has a circumferential exterior surface with a bottom edge. The exterior surfaces of the cartridge and the rotor between the element cutting edge and the rotor exterior surface bottom edge are shaped as a right circular frustoconical surface having its major diameter at the cutting edge.

A still further aspect of the invention provides a method for limiting the amount of heat transferred to bearings within a cartridge which carries a rotatable annular round self-propelled cutting element. The cutting element rotates about a cartridge axis in response to forces applied to the element when a cutting edge of the element engages a relatively moving workpiece and becomes hot as the element operates to cut material from the workpiece. The method includes the step of cooperatively configuring and defining the cutting element and components of the cartridge which contact the cutting element to define heat energy flow paths in the element to the cartridge and in those cartridge components. The defined heat energy flow paths include paths which have low thermal conductance toward the bearings and paths which have high thermal conductance to other locations in the cartridge.

### DESCRIPTION OF THE DRAWINGS

The accompanying drawings depict presently preferred structural arrangements which implement the present invention to provide the benefits summarized above and also other benefits, including positive-rake cutting and flow-control and breaking of continuous chips. The depicted arrangements are not the only forms in which the invention usefully can be embodied. In the drawings, like or closely similar structural or functional features are identified by like reference numbers. The several figures provided by those drawings are as follows:

FIG. 1 is an exploded perspective view, shown generally from the top, of an improved rotary cutting insert and an improved insert mounting cartridge shown in association with the front end of a turning tool body which is structured to receive and securely hold the lower end of the cartridge;

FIG. 2 is an exploded perspective view, shown generally from the bottom, of the insert, cartridge, and turning tool body front end shown in FIG. 1;

FIG. 3 is a perspective view of a primarily-flat mounting shim, two of which are located in the tool body front end shown in FIG. 1;

FIG. 4 is an elevation view, partly in cross-section, showing the base of the cartridge stator and adjacent turning tool body shown in FIGS. 1 and 2;

FIG. 5 is a cross-section view taken substantially along Line 5-5 in FIG. 4 through the base of the cartridge stator and the mounting shims and clamp screw, showing the cartridge and insert secured to the tool body, all consistent with FIGS. 1 and 2;

FIG. 6 is in three views, namely, FIG. 6a which is a top plan view of an improved rotary cutting insert, FIG. 6b which is a top perspective view of that insert, and FIG. 6c which is a bottom perspective view of that insert;

FIG. 7 is a side elevation view of the insert shown in FIGS. 6a-6c;

FIG. 8 is a top plan view of another improved insert;

FIG. 9 is in two views, namely, FIG. 9a which is an exploded view of the cartridge of FIG. 1, shown generally from the top, and FIG. 9b which is an exploded view of that cartridge, shown generally from the bottom; the insert and the cartridge hold-down cap for the rotary cutting insert are not shown in FIGS. 9a and 9b;

FIG. 10 is a cross-sectional elevation view, taken in an axial diametrical plane, of the cartridge shown in FIGS. 1, 2, 4, 9a and 9b, without depiction of the rotary cutting insert or of its hold-down cap;

FIG. 11 is a cross-sectional elevation view of the rotor of the cartridge shown in FIG. 10;

FIG. 12 is a cross-section view of the stator, and of other components fixed to it, for the cartridge shown in FIG. 10;

FIG. 13 is a perspective view of a boring tool defined to receive three cartridges, such as shown in FIG. 10, where one of the mounting shims for each cartridge is replaced with a slightly tapered, primarily-flat, adjustment shim that provides adjustability of the cartridge position in the radial direction of the tool body;

FIG. 14 is a perspective view of a milling tool defined to receive plural cartridges, such as shown in FIG. 10, where one of the mounting shims is replaced with a slightly tapered, primarily-flat, adjustment shim that provides adjustability of the cartridge position in the axial direction of the tool body;

FIG. 15 is a perspective view which illustrates the use of two non-adjustable oblong-shaped mounting shims in a boring tool;

FIG. 16 is a fragmentary perspective view which illustrates the use of two non-adjustable oblong-shaped mounting shims in a milling tool;

FIG. 17 is a close-up view of a non-adjustable cartridge mounting arrangement for turning tools using two round-shaped mounting shims;

FIG. 18 pertains to a mounting shim of oblong shape and is in three views, namely, FIG. 18a which is a top view, FIG. 18b which is a side elevation view, and FIG. 18c which is a perspective view;

FIG. 19 pertains to a mounting shim of substantially round shape and is in three views, namely, FIG. 19a which is a top view, FIG. 19b which is a side elevation view, and FIG. 19c which is a perspective view;

FIG. 20 is a cross-sectional elevation view which shows an embodiment of an insert with additional chip formation space and ground-in positive rake angle;

FIG. 21 shows an insert of this invention in which the face of the insert at and adjacent the insert's cutting edge defines recesses and ridges;

FIG. 22 is an axial diametrical plane cross-sectional elevation view of an insert providing heat transfer impedance and having two useable cutting edges;

FIG. 23 is a perspective view of a heat shield sleeve which is matable within the inner diameter of an insert and which is externally configured to provide thermal impedance effects;

FIG. 24 is a top plan view of another insert of this invention which is configured to provide thermal impedance effects is a direction radially of the insert;

FIG. 25 is an enlarged cross-sectional elevation view taken along line 25-25 in FIG. 24;

FIG. 26 is a perspective view, generally from the top, of a cartridge of this invention which incorporates a cuttings chip breaker;

FIG. 27 is a perspective view, generally from the bottom, of the cartridge and chip breaker shown in FIG. 26;

FIG. 28 is a perspective view, generally from the top, of a cartridge of this invention having another form of chip breaker mounted to it;

FIG. 29 is a perspective view, generally from the bottom, of the cartridge and chip breaker shown in FIG. 28; and

FIG. 30 is a perspective view showing the use of a chip deflector with an insert and cartridge assembly mounted to a turning tool body.

### DESCRIPTION OF THE DEPICTED STRUCTURES

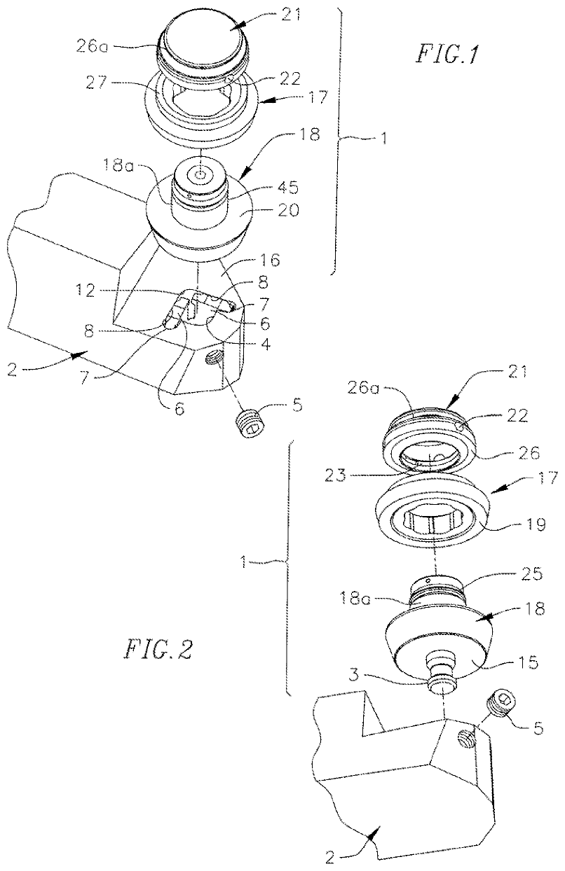

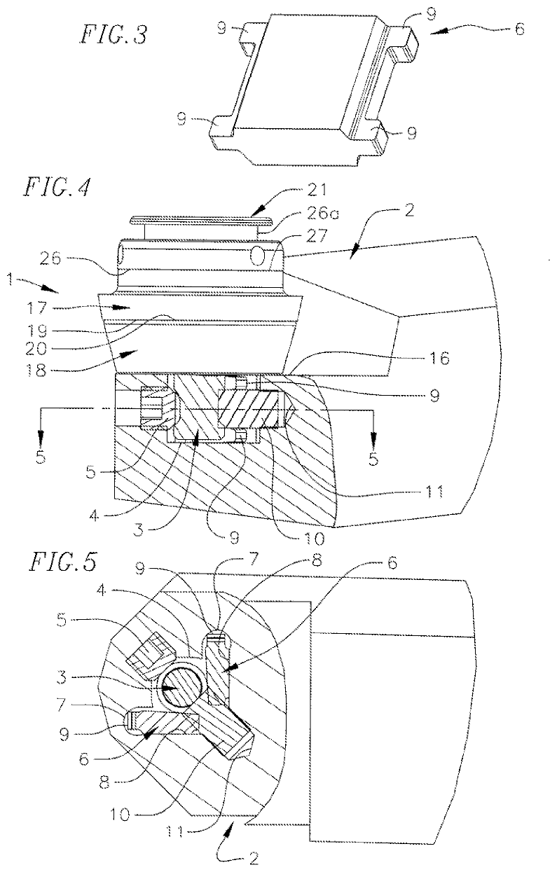

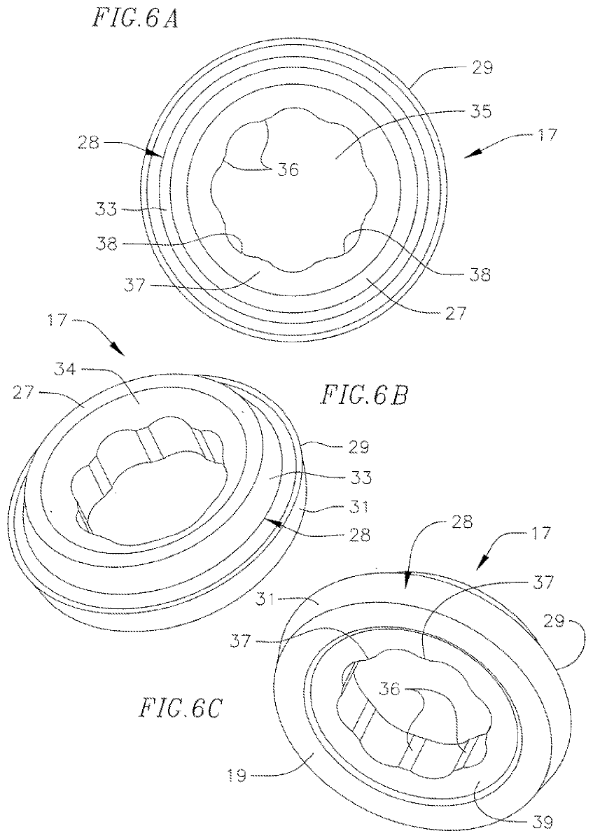

Referring to FIGS. 1 and 2, which illustrate a lathe tool application of this invention, a rotary tool system of this invention comprises a preferably axisymmetric cartridge 1 attached to the front end of a lathe tool body 2 by placing the cartridge stator base 3 (viewable in FIG. 2) into a mounting pocket 4 (FIG. 1) in tool body 2 and by clamping the stator base 3 in the tool body via tightening of a clamp screw 5. Except as shown and described, the structure of the tool body 2 may be of conventional nature toward and at its rear end (not shown). The stator base 3 is clamped in the tool body (see FIGS. 4 and 5) between the end of clamp screw 5 and two hardened mounting shims 6 (FIG. 3) that are placed into shim slots 7; the shim slots are extensions of the mounting pocket 4, as shown best in FIG. 1. As shown in FIGS. 1 and 3, the mounting shims 6 preferably have chamfers on their corners to allow an approximate fit into the rounded ends of shim slots 7 while assuring that each mounting shim 6 makes continuous flat surface contact with its shim support surface 8, which is defined by a wall of the pertinent shim slot. Furthermore, the mounting shims 6 preferably have ears 9 that, as seen in FIGS. 4 and 5, fit around a shim retainer 10 which preferably is made of a flexible material such as rubber and is inserted into a shim retainer hole 11 located in the back corner 12 of mounting pocket 4; the shim retainer 10 fits between the ears 9 on the ends of the mounting shims 6 that are located in the back corner 12 of the mounting pocket.

As shown in FIGS. 2 and 4, e.g., stator base 3 is in the form of a stub shaft which extends coaxially from the lower end of cartridge stator 55 (FIGS. 10 and 12). The stator base, intermediate its ends, is of reduced diameter between an upwardly facing conical lower clamp taper 13 and a downwardly facing conical upper clamp taper 14. FIG. 4 illustrates how, upon tightening clamp screw 5, the tip of the screw preferably initially makes contact with the lower clamp taper 13, and subsequently with the upper clamp taper 14. Initial contact of the clamp screw 5 with the lower clamp taper 13 invokes a wedging action that provides high mechanical advantage in drawing the cartridge bottom 15 (viewable in FIG. 2) tight upon the tool body seating surface 16 (see FIG. 1) in which the cartridge mounting pocket is defined. The subsequent contact of the clamp screw 5 with the upper clamp taper 14 provides additional support near the top of the stator base 3 affording additional bending support to the as-mounted stator base 3. As seen in FIG. 5, contact of the stator base 3 with the clamp screw 5 and the two mounting shims 6 provides three points of contact producing full translational constraint of the cartridge in the plane of the of tool body seating surface 16 (see FIG. 4, bottom). The hole in tool body 2 into which clamp screw 5 is threaded is oriented so that its axis is directed toward the back corner 12 of cartridge mounting pocket 4 in the tool body, as shown best in FIGS. 1 and 5.

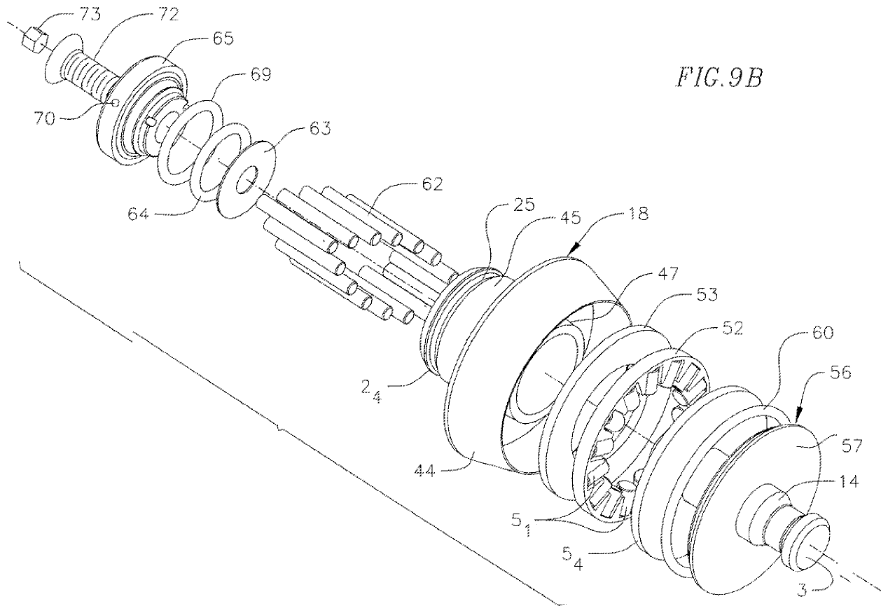

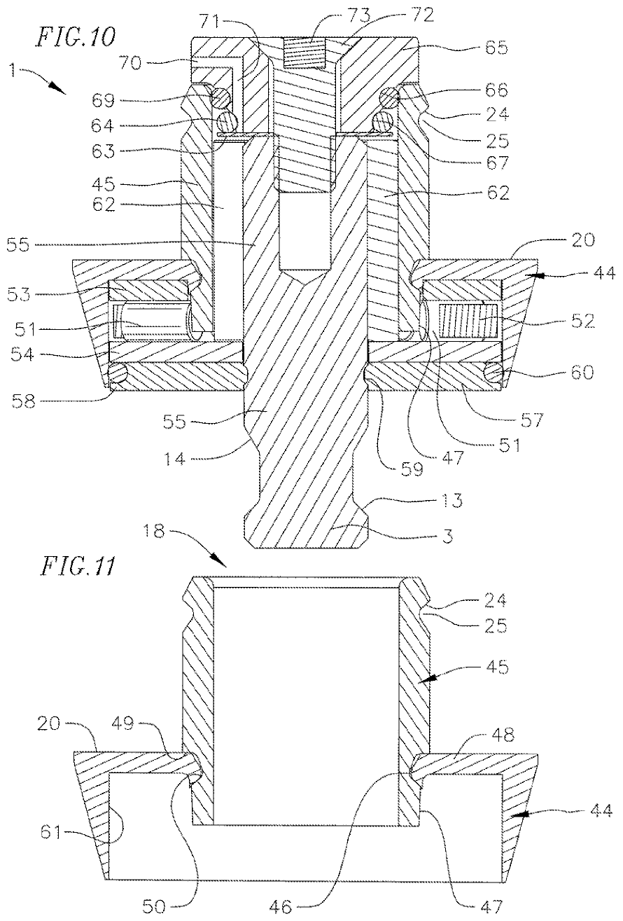

FIGS. 1 and 2 also illustrate how a self-propelled rotary cutting insert 17 can be axially slid onto the outer diameter 18a of the sleeve 45 of cartridge rotor 18, to be concentric to the central axis of the cartridge, until the insert bottom 19 contacts an insert support platform provided by a rotor seating surface 20 at the top of a skirt of the rotor; see also FIGS. 9a and 9b. The cutting insert 17 is then held in place in cartridge 1 by hold-down cap 21, which is axially snapped onto the assembly of the cartridge and the insert as the hold-down cap retaining ring 23 expands over the rotor ring-groove top 24 to settle into the ring-groove 25 in rotor sleeve 45 (see also FIG. 11). The hold-down cap retaining ring is a resilient element of circular nature with an expansion discontinuity in it, and it is carried in a groove formed in the wall of a circular recess in the bottom of cap 21; that recess is centered on the axis of symmetry of the circular cap. Upon tightening of the hold-down cap screws 22, the retaining ring wedges against the groove-side of the ring-groove top 24 of the cartridge rotor sleeve 45. This wedging action compresses the hold-down cap bottom 26 against insert top 27 and subsequently insert bottom 19 against seating surface 20 of cartridge rotor 18 with force sufficient to prevent rotation of cutting insert 17 relative rotor sleeve 45 which extends upwardly from rotor seating surface 20 formed by rotor skirt 44 (see FIGS. 9a, 9b, 10 and 11). Loosening of hold-down cap screws 22 allows the hold-down cap 21 to be removed by prying upward on the hold-down cap removal groove 26a.

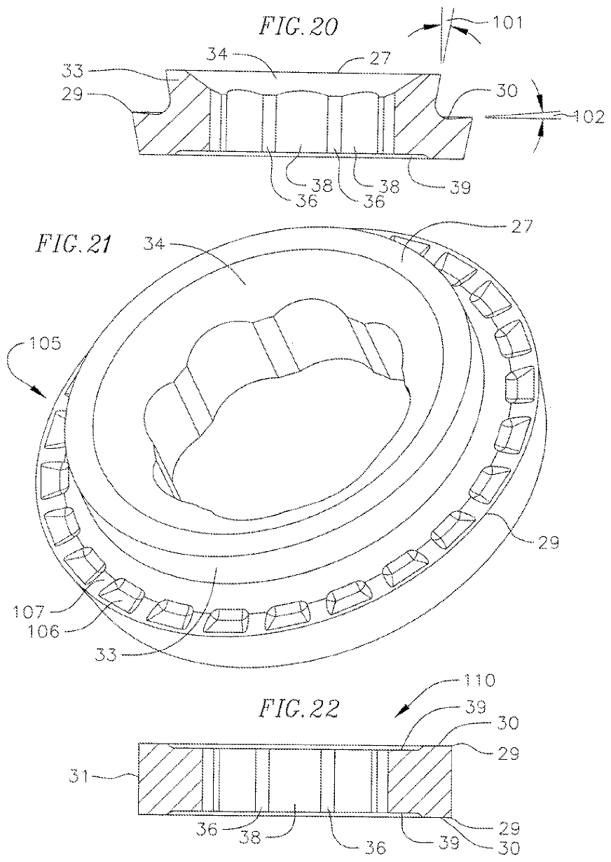

FIGS. 6a-c and 7 show a cutting insert 17. Insert 17, in common with other inserts of this invention, is an annular article of manufacture having preferably flat and preferably parallel top and bottom end surfaces which are normal to a central axis of the insert. The exterior surface of the riser between its ends is defined basically as a surface of revolution concentric to the insert's central axis in which local features, such as recesses and/or ridges, may be present. Insert 17 is comprised of an annular insert body 28 having a circumferential cutting edge 29 at the intersection of a rake face 30 (upwardly facing) and a flank face 31 (laterally facing) around the insert's circumference. The flank face 31 may have a non-zero relief angle 32, as shown in FIG. 7, for use in positive rake configurations; the relief angle 32 may be zero when the insert is used in negative rake configurations. As compared to prior commercially used inserts which have flat parallel top and bottom surfaces, insert 17 includes a top riser 33, having an outer surface 33b, a riser angle 33a, near its inner diameter such that the outer surface 33b of the riser decreases in diameter in a direction toward the hold-down cap 21. The insert riser serves several purposes, including a lowering of the cutting edge 29 relative to the axial full thickness of the insert body between its top 27 and bottom 19 surfaces, and to deflect cuttings chips to avoid significant chip contact with hold-down cap 21 and potential wedging of cutting chips between the hold-down cap bottom 26 and the insert top 27. A value of about 20° for angle 33a works well when the insert is used to cut materials, such as gray cast iron and compacted graphite iron, which form discontinuous cutting chips. A value near to or equal to 0° is preferred for use with materials such as titanium alloys, nickel alloys, carbon/alloy steels, and stainless steel which form continuous chips. In other usages, the value of the riser face angle can be negative (see angle 101 in FIG. 20), on the order of −10°, to control the chip to form a tighter curl which assists better evacuating chips from the cutting region and to break chips into more manageably sized pieces. Lowering the cutting edge 29 relative to the full insert thickness (height) facilitates achieving positive rake cutting, in particular while meeting clearance requirements on smaller diameter tool bodies used in boring processes, all while retaining greater overall thickness and resulting strength of the cutting insert 17. Preferred materials for defining the insert body are tungsten carbide, titanium carbide, silicon nitride, and ferrous alloys, among other materials known to be useful in metal cutting processes; such materials are quite hard and, with the exception of ceramic materials, have high thermal conductivity and so readily conduct heat in inserts made of them to other things with which they are in contact.

Continuing with FIGS. 6a-c, the insert top 27 meets with an upwardly concave inner hold-down cap clearance chamfer 34 which is sized and oriented to provide clearance for the hold-down cap 21. The insert top 27 preferably is flat to provide good thermal contact with hold-down cap bottom 26 so that hold-down cap 21 serves as a heat sink for improved convection and radiation of heat energy present in the insert to the environment in preference to conduction into the cartridge 1, which contains rolling element bearings which, as noted, are best protected from high temperatures. To further create preferential flow of heat energy to the environment rather than to cartridge 1 from a hot insert, the inner diameter 35 of the insert can be scalloped so that only the tops 36 of scallop peaks 37 make contact with rotor sleeve 45 (see FIG. 10) when the insert is mounted to the cartridge. Scallop tops 36 are precision machined or ground to a circularly cylindrical surface concentric with the insert's cutting edge 29 and to mate in a snug sliding fit with the outer diameter 18a of rotor 18. The air present in the scallop valleys 38 serves as thermal insulation so that the heat conduction path through the scallop tops 36 to the rotor is much less than if the insert inner diameter 35 were continuously cylindrical with constant diameter. Furthermore, cutting insert 17 preferably has a bottom recess 39 (FIG. 6a) formed, cut or ground into the insert body 28 to provide an air gap producing reduced contact with and reduced thermal conductance to rotor seating surface 20 of cartridge 1.

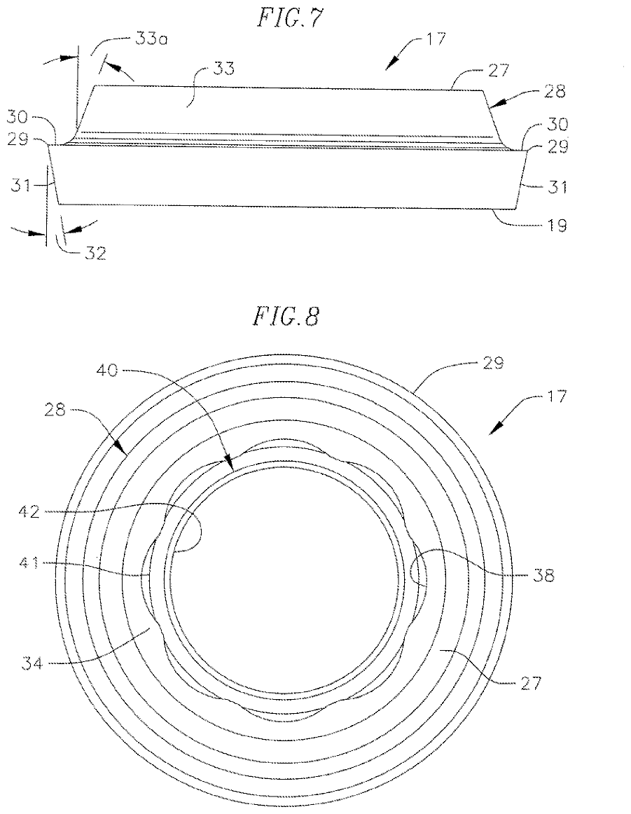

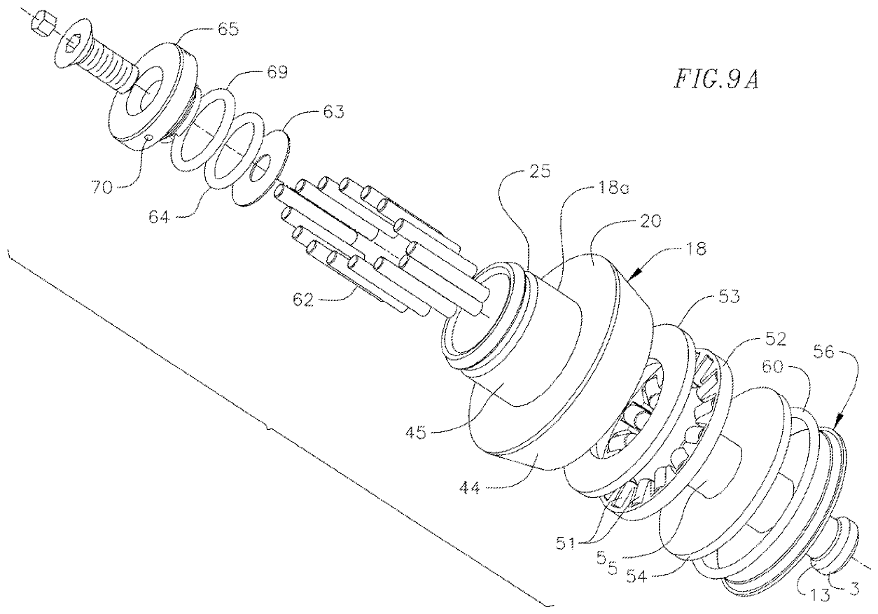

As illustrated in FIG. 8, the insert body 28 may have inserted into its inner diameter 35 a heat shield 40 made as a continuous ring of material having lower thermal conductivity than that of the insert body 28 to provide additional resistance to thermal conduction from the insert to cartridge 1. While heat shield material is preferably a metal such as stainless steel, this invention also contemplates the use of a ceramic material to define the heat shield. The heat shield 40 typically has ends that are chamfered on their outer diameter to promote centering during pressing, e.g., of the heat shield 40 into connection with insert body 28 during which the hard scallop peaks 37, no longer needing special machining for precision fit with the rotor outer diameter 18, can cut onto the heat shield outer diameter 41. The insert, with the heat shield in place, then can be precision machined or ground to form the heat shield inner diameter 42 concentric with cutting edge 29 and to snugly mate with the outer diameter 18a of rotor 18.

In implementations of this invention in which a composite insert is used, i.e., an insert having a hard relatively highly heat conductive annular outer portion defining the cutting edge and an inner relatively poorly heat conductive annular heat shield portion of a material different from that of the outer portion, the inner and outer portions of the insert may or may not contact each other continuously along the surfaces where they mate. The composite insert shown in FIG. 8 has discontinuous contact between the outer hard portion and the inner poorly conductive portions, as is preferred in the practice of the invention. The greater the ratio of the inner diameter area of the insert to the portion of that area which physically contacts the heat shield (or the rotor sleeve if there is no heat shield present), the greater is the thermal impedance of the connection of the insert to the heat shield (or to the rotor). High thermal impedance at that connection is desired.

FIGS. 9a, 9b and 10 illustrate cartridge 1 and its internal components in three-dimensional exploded views and in a cross-section view, respectively; insert 17 and hold-down cap 21 are not shown in these FIGS. Rotor 18, shown in FIG. 11, preferably is created as a permanent assembly of a skirt 44 to a sleeve 45 by partially sliding and self-centering the skirt's minor inner diameter 46 onto the sleeve bottom taper 47 and then, under the force of a pressing die, pushing the skirt top 48 (which defines the rotor seating surface 20) down to the sleeve shoulder 49 and subsequently deforming a “lump” of extra material near the skirt minor inner diameter 46 into the sleeve press groove 50. The two-piece design of rotor 18 allows the sleeve 45 to be precision machined or ground of a material (such as tool steel) suitable as a bearing surface while the skirt 44 may be made of a material and/or with precision not necessarily preferred for a bearing surface. Rotor skirt 44 preferably is defined by a material which has lower thermal conductivity than tool steel, such as stainless steel as one example. Thus, the preferably scalloped insert inner diameter 35, either with or without a heat shield 40, provides thermal resistance in the cartridge's radial direction while the insert bottom recess 39 and the choice of material for the rotor skirt 44 analogously provide thermal resistance in the cartridge's axial direction toward the bottom (mounting) end of the cartridge. The outer extent of insert recess 39 is located close to the outer bottom edge of the insert, and so the contact area between the insert and skirt 44 is an annular area at the outer extent of the skirt at the top of skirt wall 61. Such heat energy as is conducted to the skirt from the insert is transferred predominantly to the skirt wall from which that heat can be dissipated to the environment of the cartridge by radiation and by convection as the rotor turns during periods of use of the insert.

The axial load on the cartridge preferably is supported by thrust rollers 51 that are separated angularly relative to one another by a thrust roller cage 52 and are located at their outer radial ends by the cage and at their inner radial ends by the rotor sleeve bottom taper 47 within skirt 44. The thrust rollers 51 ride between a top thrust washer 53, the inner diameter of which has a slip fit over the circumference of the sleeve bottom taper 47, and a bottom thrust washer 54, the inner diameter of which preferably has a slip fit around the outer diameter of stator shaft 55 of the stator assembly 56 shown in FIG. 12. The thrust washers preferably are made of a material, such as alloy steel, suitable to define a bearing surface.

The stator assembly 56, which is shown in FIG. 12, includes a cylindrical axial stator shaft 55 which is precision machined or ground and composed of a material, such as alloy steel, suitable as a bearing surface. The stator assembly also includes a bottom washer-like retaining disc 57, having a bottom seal retaining lip 58. Disc 57 preferably is permanently attached to the stator 55 by pressing material from the disc into the stator press groove 59. The stator base 3 is the portion of the stator which lies below disc 57. It is the bottom surface of disc 57 which bears against tool body seating surface 16, e.g., when the cartridge is securely mounted to the body of a suitable turning, milling or boring tool. A cartridge bottom seal 60, such as an O-ring, made of material that is pliable and resistant to bearing lubricant and the elements to which the cutting process is exposed, preferably is located between the outer circumference of bottom retaining disc 57 and the inner diameter of skirt wall 61 in a slight interference fit, such that the bottom seal retaining lip 58 limits exposure of the bottom seal to the environment outside cartridge 1. Stator assembly 56 is inserted into the rotor housing 43 (i.e., the rotor sleeve 45) so that the bottom retaining disc 57 of the stator assembly mates with the bottom thrust washer 54 preferably earlier installed into the rotor skirt.

The radial load on the cartridge is supported by a full-complement configuration of radial bearing rollers 62 that are located to fill the elongate annular gap between the stator 55 and the inner diameter of the rotor sleeve 45. Rollers 62 preferably extend within that gap to the top surface of the bottom thrust washer 54; disposition of the lower ends of the radial bearing rollers 62 below thrust rollers 51 reduces the overall height of cartridge 1, as compared to the conventional serial arrangement of bearings shown in U.S. Pat. No. 4,477,212. The radial bearing rollers 62 are located axially at their other (upper) ends by a greasing check valve support washer 63 clamped to the top of stator 55 by the cartridge's top retainer 65 which forms a part of a closure of the cartridge. The greasing check valve support washer 63 preferably has an outer diameter slightly larger than the mean diameter of a greasing check valve seal 64, such as an O-ring, which is made of material that is pliable and resistant to bearing lubricant and the elements to which the cutting process is exposed. The cartridge's top retainer 65 defines a seal support surface 66 having an outer diameter such that the top seal 69 experiences a slight interference fit between that seal support surface and the inner diameter of the rotor sleeve 45. The top retainer 65 also defines a greasing check valve seal support surface 67 around which the greasing check valve seal 64 fits tightly with a slight expansion. The top retainer 65 preferably provides a plurality of grease access entry holes 70 extending radially inward from the circumference of top retainer 65. Each hole 70 then connects to a grease transmission hole 71 that extends substantially parallel to the axis of the retainer from the grease access entry hole 70 to the grease check valve seal support surface 67. The pressure of grease injected into the cartridge via the passage formed by holes 70 and 71 expands radially outward the resiliently expandable grease check valve seal 64 allowing grease to enter the cartridge. Grease check valve seal 64 normally seats tightly against the grease check valve seal support surface 67 preventing grease from flowing back out of the cartridge 1. The top retainer 65 is held in place on the stator by top screw 72 which is threaded into the top of stator 55, preferably along with a suitable amount of a thread locking compound. Preferably, the tightening socket in the head of top screw 72 is then filled with a hardenable filler material 73, after which any extra outwardly protruding filler material and non-flush exposed portion of the screw head are machined flush with the nominal top surface of the top retainer 65 to discourage tampering with the top screw. Cartridge 1 preferably is defined as an article of manufacture which is not openable by a user of the cartridge, and into which a user can inject fresh grease when needed.

FIG. 4 includes a side elevation view of the assembled insert and cartridge combination or assembly. It will be noted that the maximum diameter of that assembly coincides with the insert cutting edge (not numbered in FIG. 4 but see FIG. 7, e.g.), and that below that maximum diameter the exterior surface of the assembly has the contour of a right circular frustoconical surface the diameter of which decreases proceeding downward from the upper end of that surface. It also will be noted from FIG. 4 that the plane of the insert cutting edge has a position in that assembly which is close to midway between the top of assembly and the location vertically in the assembly where the cartridge stator engages tool mounting surface 16. The inverted frustoconical configuration of the combination of the exterior surface of the insert below its cutting edge and the lower extent of rotor skirt 44 (see FIG. 11) makes it possible for the cartridge-insert assembly to be mounted to a tool body in such a way that the insert rake face 30 has positive rake with respect to a workpiece. The ability of a cartridge insert assembly of this invention to be used in positive rake machining applications, such as end milling operations, is significant and cannot be achieved with cartridge-insert assemblies using cartridges of the kind depicted in U.S. Pat. No. 4,477,211.

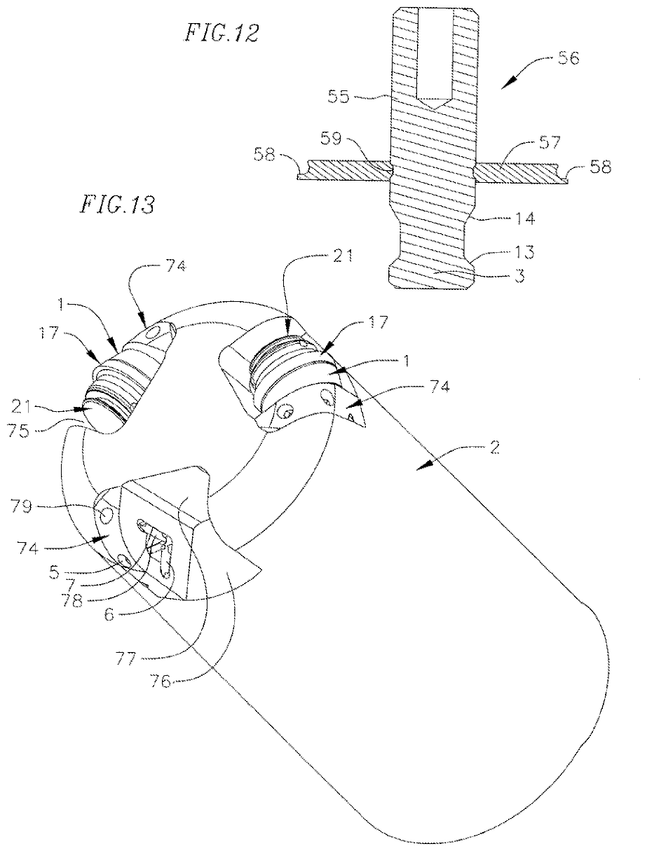

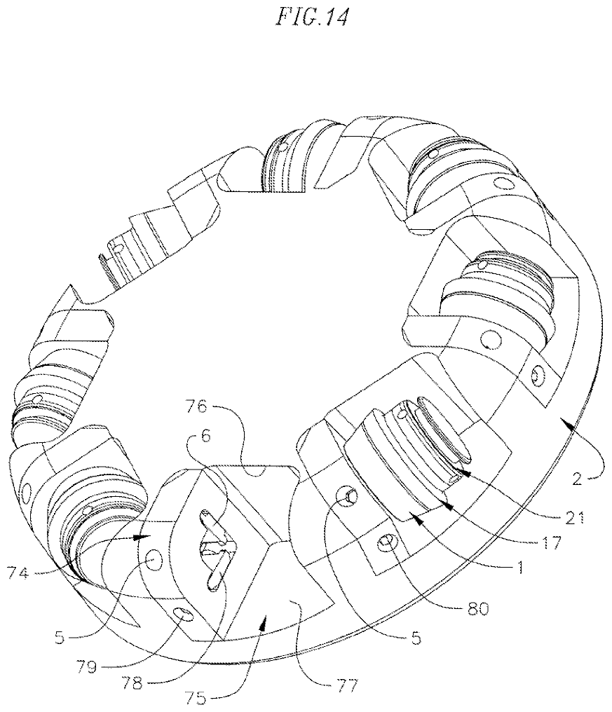

FIGS. 13 and 14, respectively, illustrate cylinder boring and face milling tools capable of carrying plural cartridges and inserts according to this invention. In FIGS. 13 and 14, one cartridge has been removed to expose its mounting region on the tool body. The mounting features for the cartridge are first machined into a mounting plate 74 that is then affixed in a cartridge pocket 75 which is machined into the tool body 2 to yield the radial and axial rake angles required for inducing desired insert rotation via the side rake angle (axial in boring; radial in face milling) and to provide positive or negative back rake angle (radial in boring; axial in face milling), i.e., the rake angle that primarily regulates chip strain during chip formation as the rotary cutting inserts act to cut a workpiece. The mounting plate 74 is located by the pocket axial (i.e., axially facing) wall 76 and the pocket radial (i.e., radically facing) wall 77 and may be affixed to the tool body with welds and/or adhesives.

The mounting plate 74 for boring and milling tools has all the same mounting-related features as described above in regard to the turning implementation of the invention as shown in FIGS. 1, 2 and 4 with the following preferred three differences. First, one of the two mounting shims (leaving one mounting shim 6) is replaced by an adjustment shim 78. The one mounting shim which is replaced is the one that locates the cartridge in the depth-of-cut direction, i.e., the radial direction for boring and the axial direction for face milling, the purpose being to allow tooth-to-tooth alignment, in the field, so all inserts are cutting at the same depth to produce a good surface finish, or at a prescribed stagger in some boring applications as described in U.S. Pat. No. 6,135,680. An adjustment shim 78 is identical to a mounting shim 6 with the exception that the adjustment shim surface which the stator base 3 contacts has a slight taper so that as the adjustment shim 78 moves inward and outward in its shim slot 7, the position of cartridge 1 in the depth-of-cut direction changes in ratio to the pitch of the taper. As the second difference, a shim adjustment hole 79 is added in the mounting plate, into which a shim adjustment screw 80 is threaded to enable movement of the adjustment shim 78. The third difference is that the shim retainer hole 11 in mounting plate 74 which receives the shim retainer 10 is oriented along the direction of the shim slot 7 corresponding to the adjustment shim 78. The shim retainer 10 serves as a spring that urges the adjustment shim 78 against its adjustment screw. The shim retainer may be a standard helical spring or it may be of solid elastomeric material having altered/tapered end geometry to facilitate assembly of the single mounting shim 6 and the single adjustment shim 78 into their respective shim slots.

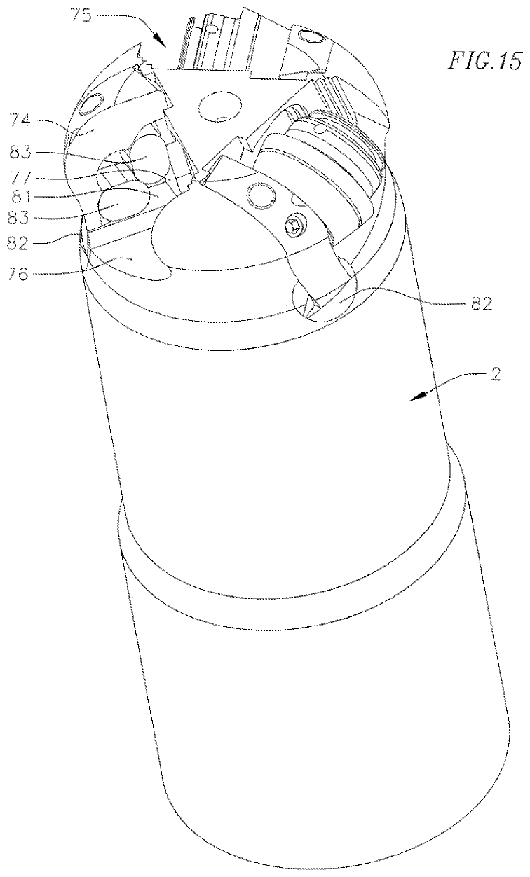

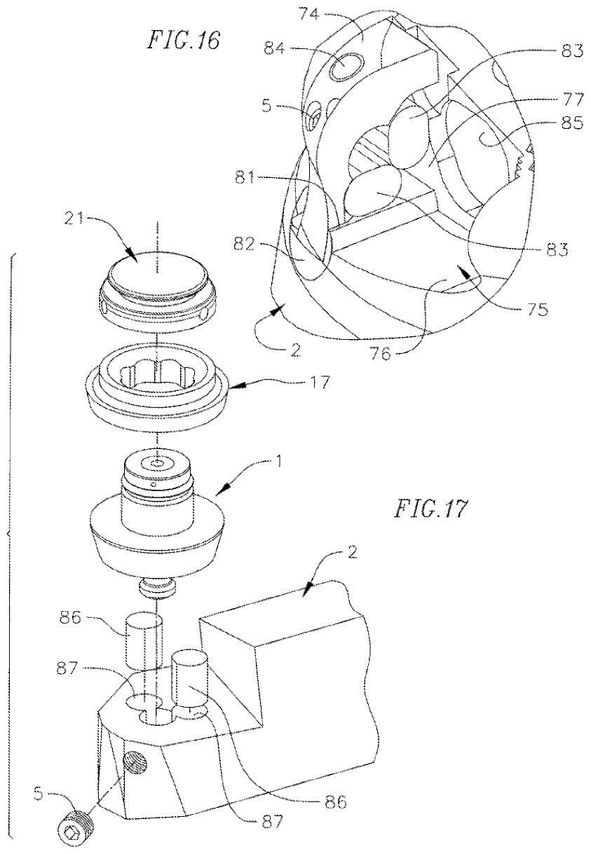

FIGS. 15 and 16 show a cartridge mounting arrangement useful in boring and milling tools in which field adjustability via adjustment shims is eliminated and is replaced with factory-grinding of shims for the purpose of fine positioning of the multiple cutters of the tool for the purposes noted earlier. As shown best in FIG. 16, in this arrangement, one mounting shim is mated directly against the pocket radial wall 77 (the pocket wall which faces radially away from the center of the tool body) and, instead of against the pocket axial wall 76, against an axially facing surface 81 of a mounting plug 82 supported in the pocket axial wall 76. This arrangement enables factory adjustment of cartridge position by grinding each set of shims as needed. The elimination of field adjustability permits the elimination of a shim adjustment hole 79, shim adjustment screw 80, and shim retainer 10. FIG. 16 is a close-up perspective view of a milling tool pocket 75 with two oblong mounting shims 83, shown in more detail in FIGS. 18a-c. Mounting plug 82 can be held in place by a weld while the other end of the mounting plate 74 and its bottom surface can be affixed with welds and/or adhesives. The shims preferably are held in place with a shim locking screw 84. FIG. 16 also shows an optional insert clearance cavity 85 in the pocket radial wall. FIG. 17 shows a similar cartridge mounting arrangement for a turning tool where the shim slots 7 have been removed from the mounting arrangements illustrated in FIGS. 1 and 2, and the primarily-flat mounting shims 6 have been replaced with round mounting shims 86 that are pressed into shim receiving holes 87.

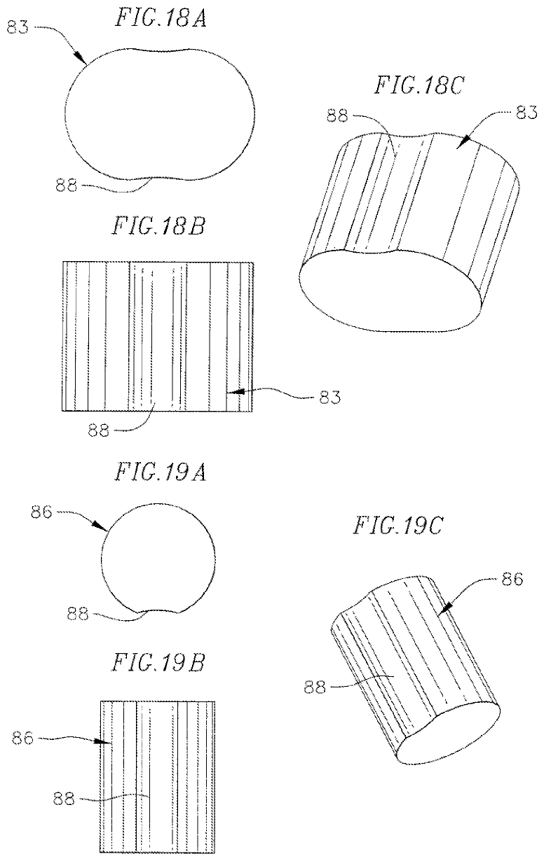

FIGS. 18a-c show an oblong mounting shim 83 and FIGS. 19a-c show a round mounting shim 86. In each of shims 83 and 86 the stator contact surface 88 which engages the base 3 of cartridge stator 55 can be either flat/planar, or it may be concave as shown in FIGS. 18a and 19a, the radius of concavity preferably being at least slightly greater than the radius of the stator base 3.

FIG. 20 is a transverse cross-sectional elevation view of another insert 100 of this invention. Insert 100 has the features and characteristics of insert 17 as described above except for the particular configuration and contour of its rake face 30 and its riser 33. In insert 100, the riser surface above rake face 30 slopes upwardly at an angle 101 which is closer to 0° than angle 33a of insert 17. Angle 101 can be negative as shown. Also, FIG. 20 shows that, if desired, rake face 30 can have an optional, preferably ground-in positive angle 102 at cutting edge 29.

FIG. 21 is a top perspective view of another insert 105 of this invention which, like insert 100, is configured to provide impedance to the radial transfer of heat in the insert to its supporting structure such as cartridge 1. Insert 105 has recesses 106 formed in its rake face closely adjacent to the insert's cutting edge 29. The recesses are regularly spaced apart around the circumference of the insert. The spacing between the ends of adjacent recesses preferably is less than the length of a recess in a direction around the insert. The recesses can extend into the riser face, if desired. The insert can have ridges 107 which are raised above the nominal rake face and which extend radially of the insert on the rake face (between adjacent recesses 106 if recesses are present) and upwardly along the insert riser as far above the rake face as may be desired. The recesses, ridges, or both recesses and ridges provide added traction between the flowing chips and the insert, enhancing the torque provided to rotate the insert in its mounting cartridge. Though not shown in cuttings FIG. 21, recesses and/or ridges may be present only on the riser without their counterparts on the rake face.

FIG. 22 shows a two-sided insert 110 which may be used specifically for cutting at a negative rake angle. Insert 110 can be thicker in an axial direction than the other inserts described herein because there is no need to lower the cutting edge 29 below the top of the insert as is needed in space-limited positive rake applications. Insert 110 preferably has an insert bottom recess 39 on both its top and bottom, as insert 110 can be flipped over and used equivalently upside down. Insert 110 has thermal impedance features as shown and as described above.

The combination of a hard relatively highly thermally conductive insert 17 axially scalloped (fluted) at its inner diameter with a relatively poorly thermally conductive annular heat shield 40 having its outer surface engaged with the peaks between the insert scallops significantly reduces the amount of heat which can be conducted from the outer portion of the insert to sleeve 45 of cartridge rotor 18. That reduction in heat flow to the rotor along the path from the outer portion of the insert to the rotor is achieved for two reasons. First, the path includes the poorly conductive heat shield; the heat shield's poor thermal conductivity provides a thermal impedance effect which reduces that heat flow. Second, the reduction in the area of physical contact between the insert and the heat shield, caused by the scalloping (fluting) of the inner diameter of the insert, produces a further thermal impedance effect. Those two heat conductance reductions in the flow of heat along that path are obtained because the ability of heat energy to move conductively along a path is dependent on the thermal conductivity of the materials defining the path, the lengths of the materials in the path, and the cross-sectional area of the path. The scallops 38 in the inner diameter of insert 17 reduce the cross-sectional area of the relevant conductive heat energy flow path.

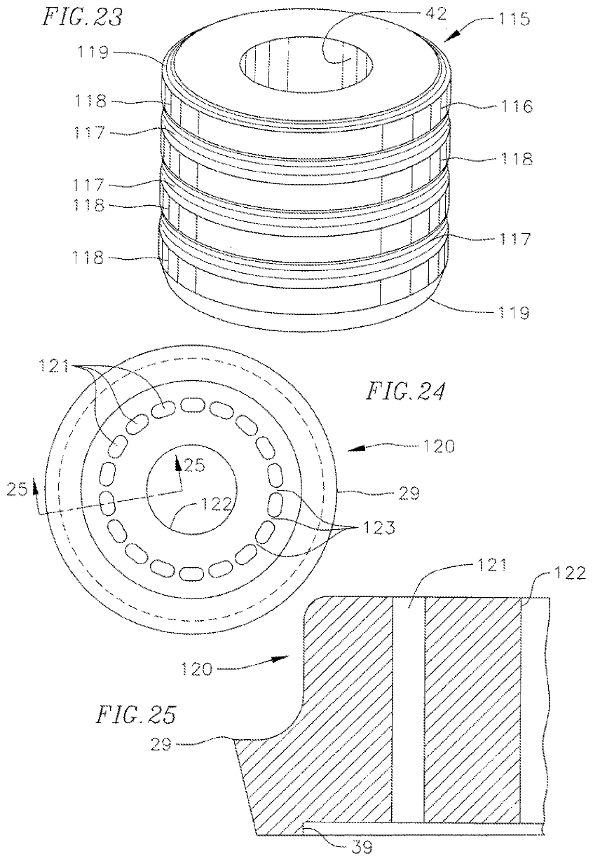

The thermal impedance of the heat flow path from the insert 17 to rotor 18 can be increased further by providing circumferential scallops in the outer diameter of an insert heat shield as shown in FIG. 23. FIG. 23 is a perspective view of an annular insert heat shield 115 in which the outer surface 116 is effectively scalloped (fluted) by a plurality of shallow circumferential grooves 117 formed in that surface to create between them and the ends of the heat shield a plurality of lands (ridges) 118 which, in turn define the outer diameter of the shield. The outer end surfaces of the insert preferably are chamfered, as at 119, to enable the shield to be pressed, e.g., into the inner diameter of its insert such as insert 17 as shown in FIG. 8. When heat shield 115 is placed in the inner diameter of insert 17, physical contact between the insert and the heat shield occurs only at those spaced places in the interface between them where insert scallop peaks 37 engage heat shield lands 118; those places are spaced axially and circumferentially over the interior of the insert and the exterior of the heat shield.

By way of example, assume that insert 17 is defined by tungsten carbide which has a relative coefficient of thermal conductivity of 80 (a reasonable value taken from the range of 70-100 for that material), heat shield 115 is defined by stainless steel having a relative coefficient of thermal conductivity of 15, and for a matter of simplicity, that the coefficient of thermal conductivity of air contained in any contact discontinuities is zero (i.e., being negligibly small relative to those of the solids). Assume also that the radial distance from the heat source at the cutting edge 29 to the rotor outer diameter 18a is 6 mm, 2 mm of which is consumed by the thickness of the heat shield 115 when one is present, and that the area of scallop peaks 37 of the insert is 25% of the area of the inner surface area of an unscalloped insert of equal thickness and inner diameter, and that the area of heat shield 115 defining lands 118 is 50 percent of the outer diameter of an equivalent ungrooved heat shield 40, and that the scallops are 0.5 mm in height from their tops 36 to their valleys 38 while the depths of the grooves 115 are 0.5 mm. Applying those assumptions and treating the conduction in a Cartesian sense as an approximation to the cylindrical nature of the actual geometry, as compared to an unfeatured inner surface of the insert and an unfeatured outer surface of the heat shield which are of equal axial extent, the presence of the heat shield in the insert reduces the conductance of the heat energy flow path from the insert to the cartridge rotor to [(4/80+2/15)⁻¹480/6)]×100=41% of the conductivity of such unfeatured flow path. That means that flow of heat into the cartridge will be 59% less preferable, relative to without the heat shield, and thus a greater percentage of the total heat energy from the source will flow along other paths, rather than to the cartridge, to be removed from the insert. Simplifying for the purpose of general illustration the three-dimensionality of the thermal conductance in the locale of the scallops and grooves, if the scalloped insert were to be engaged with an ungrooved heat shield, the conductance of the heat energy flow path from the insert cutting edge 29 to the cartridge rotor surface 18a becomes [(3.5/80+0.5/(80×0.25)+2/15)⁻¹/(80/6)]×100=37%, relative to an unfeatured insert and an unfeatured heat shield. Furthermore, when the scalloped insert is mated to circumferentially grooved heat shield 115, the reduction in the conductance of heat energy flow path of interest becomes [(3.5/80+0.5/(80×0.25×0.5)+0.5/(15×0.25×0.5)+1.5/150(80/6)]×100=16%, relative to the case of an unfeatured insert and an unfeatured heat shield.

The thermal impedance enhancing techniques and arrangements described above, including those illustrated in FIGS. 8 and 23, can be practiced or used in the interface between an insert, with or without a heat shield carried by the insert, and cartridge rotor sleeve 45, if desired. In such a case, the exterior of rotor 45, in the portion of its extent above skirt top 20 which is radially adjacent the insert, can be circumferentially grooved in the manner shown in FIG. 23.

As noted above, one technique for increasing thermal impedance in the heat energy flow path to cartridge rotor 18 is to reduce the cross-sectional area of the path. FIGS. 24 and 25 illustrate an application of that technique within the hard, highly thermally conductive material of a self-propelled rotary metal-cutting insert. FIG. 24 is a top plan view of an insert 120 which can have an overall height and configuration consistent with the foregoing description. FIG. 25 is a fragmentary cross-sectional elevation view of insert 120 taken along line 25-25 in FIG. 24. In insert 120, a plurality of passages 121 are defined through the insert material. Passages 121 preferably are defined to open to a bottom recess 39 in the insert, to be parallel to the central axis of the insert, and to be regularly spaced along a circle having a radius from the insert axis which has a length intermediate the lengths of the radius to the insert cutting edge 29 and of the radius of the insert's inner annular surface 122. The cross-sectional shape of each passage can be oval as shown in FIG. 24. The portions 123 of the insert which are on the passage circle are narrow and thus form restrictions in the area of a heat energy flow path from adjacent cutting edge 29 to the insert's inner surface 122 and so increase the thermal impedance of that path.

It was noted above that the selection of materials with differing coefficients of thermal conductivity to define an insert and relevant portions of an insert mounting cartridge can provide desired thermal impedance increases in heat energy flow paths to the cartridge bearings, thereby making other flow paths more significant to dissipation of heat present in the insert. Approximate relative values of thermal conductivity k of some useful materials are as follows:

| | |
|---|---|
| Macor machinable glass ceramic | 1.5 |
| Ti—6Al—4V alloy | 7 |
| 304 Stainless Steel | 15 |
| Silicon nitride | 25 |
| Carbon steel | 50 |
| Tungsten carbide | 70-100 |

Preferably, the insert material has a relative k of 25 or more and the material of a heat shield for the insert has a relative k of 15 or less.

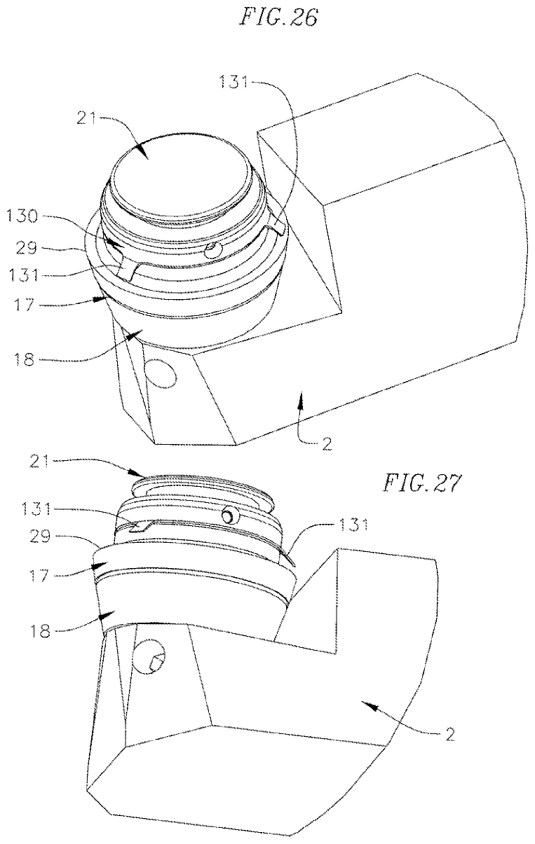

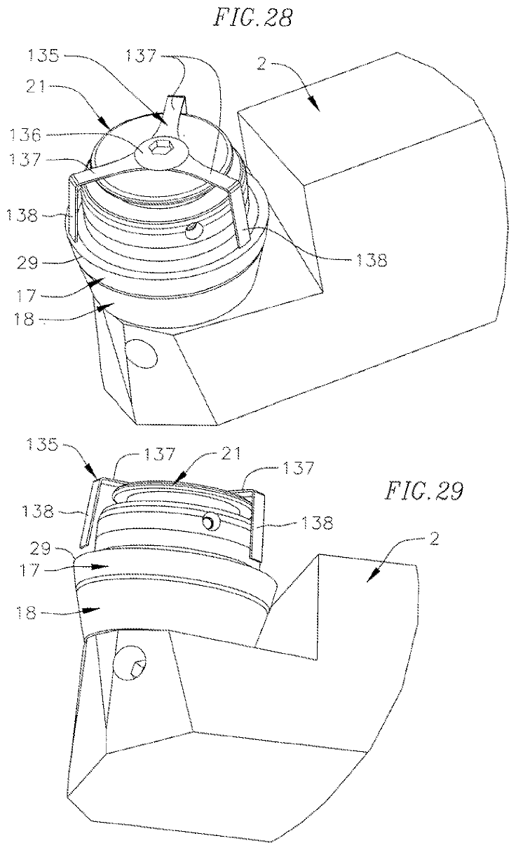

For materials that form inherently continuous chips, in particular those that resist chip breaking, such as but not limited to titanium, nickel alloys and steels, chip breaker tabs can be included in a cartridge of this invention. Under lighter machining conditions, in particular in terms of depth of cut, where the chip curls tightly such that it completes its chip curl before contacting the workpiece surfaces, the chip forms a helix that flows ahead of the tool primarily in the feed direction. However, under heavier machining conditions, in particular in terms of depth of cut, the chip curl radius is larger resulting in the chip contacting the workpiece surface prior to completing its curl, at which time it backward bends and breaks, facilitated by the tensile stress on the rough side of the chip acting on the stress concentrations associated with said roughness. However, in many instances the chip breaking is incomplete and a long segmented chip results, which can flow back toward the cutting zone where it may be re-cut and/or accumulate on tooling surfaces. Tabs that rotate past the cutting zone with insert rotation serve to sideways bend the chip, resulting in complete breaking of the chip as a result of the bending moment acting at the various stress concentrations and near-complete breakage points between the chip segments, and subsequent projection of the broken chips ahead of the tool. FIGS. 26 and 27 show how chip breaking can be achieved with chip breakers which rotate with an insert. Chip breaker 130 can be a thin metal disc of about the same diameter as the cartridge hold-down cap 21 which can be clamped between the hold-down cap bottom 26 and insert top 27 so that the insert, the hold-down cap and the chip breaker all rotate together about the cartridge axis. Tabs 131 can extend a desired distance outwardly and downwardly from spaced locations along the edge of that disc to engage and break cutting chips at locations closely adjacent to the insert cutting edge 29.

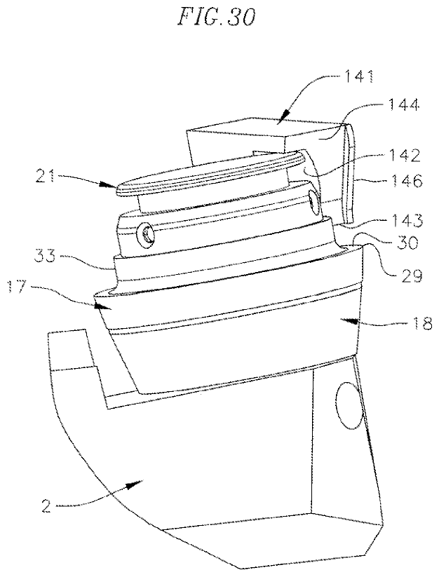

FIGS. 28 and 29 show another chip breaker 135 which can be attached to the top of the hold-down cap 21 to rotate with the cap. Chip breaker 135 can be made from thin steel sheet and can have a central hub which can be clamped to the top of hold-down cap 21 by a screw 136 extending through the hub into a tapped hole in the top center of the cap. A plurality of fingers 137 can extend radially from the hub to beyond the radius of cap 21 where they can be bent downward to form chip breaking tabs 138. Alternately, the chip breaking tabs could be integrated directly into the hold-down cap 21 (not illustrated). The tabs 131 and 138 preferably extend outward radially to a diameter slightly less than the diameter of the cutting edge 29. Tabs 131 and 138 may lie in a single axial plane, or they extend down into a chip formation space 140 at an angle as in FIGS. 26 and 28, though not to the extent that chips cannot form between the insert rake face and the tab ends, or near to or exactly vertical following the surface of insert riser 33 to serve, in addition to chip breaking, a similar purpose as do riser ridges.

Rotating chip breakers, such as chip breakers 130 and 135, cannot be provided as components of prior art rotary insert and cartridge sets of the kind shown in U.S. Pat. No. 4,477,211. The reason is that the top end structures of such cartridges are stationary so that such structures can be engaged by clamp elements mounted to the tool body which provide structural fixed support to the top ends of such cartridges.

As a further way to obtain chip control and breaking, under even heavier conditions, in particular in terms of depth of cut, where chips become so large that they may not consistently evacuate the space between a chip breaker tab 131 or 138 and the insert riser 33, a chip deflector may be used as illustrated in FIG. 30. The deflector guides the chip with additional sideways motion ahead of the tool in the feed direction, causing side bending and preferential flow away from the cutting zone. A deflector body 141 can be attached to the tool body 2 or to the machine tool mounting system in a manner per the application. The deflector has a pocket 142 that mates closely but not necessarily in radial contact with the hold-down cap 21 and insert riser 33, while also having a ledge 143 that covers part of the insert top 27 near its outer diameter. When the chip flows axially upward from the rake face 30 curling against and then away from the riser 33, it encounters the deflector chute surface 144, which preferably slopes upwardly and forwardly relative to body 41 at an angle that is preferably between 0 and 90 degrees, extending from a point slightly above the rake face 30 and upward toward the hold-down cap 21. The deflector chute surface 144 may or may not have a forwardly extending deflector chute lip 146, the purpose of which is to better assure the chip does not slip between the deflector body 141 and the workpiece, but rather remains flowing along the deflector chute surface 144.

In the light of the foregoing descriptions of certain presently preferred embodiments of the invention, it will be appreciated that one aspect of the invention focuses upon control of heat generated in a self-propelled rotary metal-cutting insert, rotatably carried in a cartridge secured to a tool body, as the insert operates to cut a workpiece. Control of heat flow in the insert is achieved in several ways, including: a) defining the insert, by its geometry or its materials (composite inserts such as shown in FIG. 7), or by a combination of geometry and materials, so that it can transfer a significant portion of its heat energy to ambient fluids such as air or machining lubricants or coolants in the vicinity of the operating insert and the cartridge hold-down cap, thereby reducing the portion of the insert's heat energy available for conductive transfer to the structure of the cartridge; and b) defining the cartridge, both geometrically and compositionally, so that flow paths in the cartridge for heat energy transferred to the cartridge from the insert are defined to preferentially route such transferred heat energy to the environment of the cartridge (e.g., to surrounding air) and/or to the tool body rather than to and through the radial-load and thrust-load bearings within the cartridge. While the heat control aspects of this invention can be used to advantage in inserts and cartridge of any desired and effective size, those aspects have particular significance and utility where small cartridge size is important.

The foregoing descriptions and the accompanying drawing views are not an exhaustive catalog of the structures and procedures which can be used to practice the several described aspects of this invention. Those descriptions and views have been selected, presented, and addressed to a person ordinarily skilled in the relevant art and technology, in support of descriptions and explanations of the principles of the invention and presently preferred and other structures and procedures which can enable such a person to understand and practice in the invention. Such a person will appreciate that, especially in light of those descriptions and views, other structures and procedures can be used to advantage within the fair scope of the invention as set forth in the following claims.

What is claimed is:

1. A self-propelled rotary metal-cutting insert comprising:
a body having a central axial hole extending between opposite ends of the body and by which the body can be mounted for rotation about its axis during and in response to cutting engagement of the insert with a workpiece, the body having an exterior surface which extends between the body ends and is defined as a surface of revolution concentric to the body axis, the exterior surface defining a circular cutting edge concentric to the body axis, the body being defined to impede the transfer of heat generated at the cutting edge across the surface of the central hole of the body, wherein the body is comprised a) by an outer portion which includes the cutting edge and which is comprised by a first material which has a characteristic coefficient of thermal conductivity k₁ and b) by an inner portion which includes the insert central hole and which is comprised of a second material which has a coefficient of thermal conductivity k₂ which is materially lower than k₁.

2. An insert according to claim 1 in which the first material is substantially metallic and the second material is a ceramic.

3. An insert according to claim 1 in which the first material is selected from the group consisting of tungsten carbide, titanium carbide, silicon nitride, and carbon alloy steel.

4. An insert according to claim 3 in which the second material is stainless steel.

5. An insert according to claim 1 in which the value of k₁ is substantially relatively 25 or greater and the value of k₂ is substantially relatively 15 or lower.

6. An insert according to claim 5 in which the value of k₁ is at least about 70.

7. An insert according to claim 1 in which the first material is present in the outer portion as an outer annular component of the body and the second material is present in the insert as an inner annular component of the body and is affixed to the outer annular component.

8. An insert according to claim 7 in which the outer annular component of the insert body is affixed to the inner annular component continuously about the outer circumference of the inner component.

9. An insert according to claim 7 in which the outer annular component of the insert body contacts the inner annular component only at spaced locations about the circumference of the inner component.

10. An insert according to claim 7 in which the outer annular component of the insert body contacts to the inner annular component only at locations spaced along the length of the inner component.

11. An insert according to claim 7 in which the outer component contacts the inner component only at locations spaced along the length and along the circumference of the inner component.

12. An insert according to claim 1 in which the cutting edge is defined in the exterior surface of the body at a location on the body which is substantially between the ends of the body.

13. An insert according to claim 1 in which substantial portions of the exterior surface of the body exist on opposite sides of the cutting edge.

14. An insert according to claim 1 in which at least the radially outer portion of the body is comprised of a material which is substantially homogeneous and which is arranged to define in the body a plurality of elongate cavities disposed substantially parallel to the body axis and located at spaced positions angularly about that axis.

15. An insert according to claim 14 in which the cavities open to the exterior of the body at least at one of the opposite ends of the cavities.

16. An insert according to claim 14 in which the cavities are open at their opposite ends to form passages through the body.

17. An insert according to claim 14 in which the cavities are substantially regularly spaced in a substantially circular pattern disposed substantially concentric to the body axis.

18. An insert according to claim 1 in which one end of the body is a base end at which the body defines a flat base surface perpendicular to the body axis, and the base surface defines a recess concentric to the body axis, the recess having an outer limit proximate to but inwardly from the body exterior surface.

19. An insert according to claim 18 in which the exterior surface of the body extends inwardly from the cutting edge and then upwardly to a top end of the insert.
